(19) United States
(12) Patent Application Publication
(10) Pub. No.: US 2009/0247366 A1
(43) Pub. Date: Oct. 1, 2009

(54) METHOD AND APPARATUS FOR CONFIGURING FITNESS EQUIPMENT

(76) Inventor: John D. Frumer, Bowdoinham, ME (US)

Correspondence Address: SEYFARTH SHAW LLP, WORLD TRADE CENTER EAST, TWO SEAPORT LANE, SUITE 300, BOSTON, MA, 02210-2028, US

(21) Appl. No.: 12/408,422

(22) Filed: Mar. 20, 2009

Related U.S. Application Data
(60) Provisional application No. 61/039,521, filed on Mar. 26, 2008.

(51) Int. Cl. A63B 26/00; F03G 5/06

(52) U.S. Cl. 482/2; 290/1 R

(57) ABSTRACT

A system and method for generating energy with human powered devices and providing environmental feedback to users is disclosed which motivates individuals to use the equipment for the purpose of improving the environment. Fitness equipment is fitted with energy conversion devices such as electric generators to convert human powered energy to electrical energy. Energy that is generated by the user is converted to a quantitative or qualitative environmental feedback parameter. The environmental feedback parameter is indicative of the user's positive effect on the environment as a function of the energy generated by their use of the fitness equipment. The environmental feedback parameter is displayed to the users during their use of the equipment, and may be stored as a log of individual session use, or cumulative total use, for later examination by the users or for group use.

### RELATED CASE INFORMATION

This application claims benefit of U.S. Provisional Application No. 61/039521, filed Mar. 26, 2008 which is incorporated herein in its entirety.

### FIELD OF THE INVENTION

The present invention is in the field of fitness equipment and more particularly relates to the configuration of fitness equipment to generate and deliver power while providing environmental feedback to the user.

### BACKGROUND OF THE INVENTION

Energy expended by people performing physical exercise can be converted into useful energy by using generators and other energy conversion devices. Human powered generators are well known and have been the subject of many patented inventions. For example, U.S. Pat. No. 4,389.047 to Hall and U.S. Pat. No. 3,210,643 to Stern each describe early human powered generators. However, devices for converting human power to useful energy have not become popular because the amount of energy that can be generated by a single person is quite small.

Collectively, the amount of energy expended by humans during exercise is very large. For example, in many fitness centers dozens of fitness machines are used almost continuously during a given day. The energy expended by fitness center clients is almost entirely lost as heat. U.S. Pat. No. 7,005,757 to Pandian discloses a system which collects energy generated by large numbers of children as they play in a playground. The '757 patent effectively incorporates one or more air pumps into various pieces of playground equipment, and the pressurized air compressed by use of the playground equipment is used to drive one or more electric generators. It is likely that the cost of deploying the specialized equipment that would be required to implement a system like the one disclosed in the '757 patent would be quite large and would not be justified in light of the monetary value of the total amount of energy that could be generated by using such a system. Such systems for collecting human power are unlikely to become popular because municipalities will be unable to justify the expense of installing specialized equipment.

Thus, various systems for human powered generation of energy using fitness equipment and playground equipment are known but are not generally economically feasible.

### SUMMARY OF THE INVENTION

Illustrative embodiments of the present invention provide an economically viable system and method for collecting energy generated by human powered devices. Embodiments according to the invention provide feedback to users which motivates them to use the equipment for the purpose of improving the environment. A human powered device is fitted with energy conversion devices such as electric generators to collect, store, or directly utilize, human energy. The human powered device is configured to redirect electrical energy generated by the device in a desired manner, for example, back to the power grid, into a battery, for direct utilization or direct equipment charging. The amount of energy generated by individual users or groups of users which is contributed to the total power being generated is measured and converted to a quantitative or qualitative environmental feedback parameter. The environmental feedback parameters are indicative of the users' positive effect on the environment as a function of the energy generated by their use of the fitness equipment. The environmental feedback parameters can be displayed to the users during their use of the equipment and may be storable for later review.

In one embodiment, a fitness center may connect a plurality of power generating fitness equipment together so that energy generated by the plurality can collectively be stored, directly utilized or provided to the power grid. Illustratively, all of the energy generating devices in a particular fitness center are connected to the grid through a single inverter. The fitness center operators may be motivated to deploy energy generating systems by receiving a reduction in their periodic energy bills or receipt of carbon credits for supplying energy back to a power grid and by attracting more new members who are motivated to help the environment. Members can be correspondingly motivated with rewards for energy production. It is envisioned that participation in human powered energy generation projects which utilize various embodiments of the present invention may be encouraged by government subsidies. For example, a health club or other facility which encourages the collection and distribution of energy generated by human powered devices may become a more viable candidate for government grants or subsidies to entities involved in green energy initiatives and/or public health improvement initiatives.

### BRIEF DESCRIPTION OF THE DRAWINGS

The foregoing and other features and advantages of the present invention will be better understood from the following detailed description of illustrative embodiments, taken in conjunction with the accompanying drawings in which:

FIG. 1 is a schematic block diagram illustrating a system for utilizing human powered energy according to an illustrative embodiment of the present invention; and

FIG. 2 is a process flow diagram illustrating a method for using fitness equipment to generate power according to an illustrative embodiment of the present invention.

### DETAILED DESCRIPTION

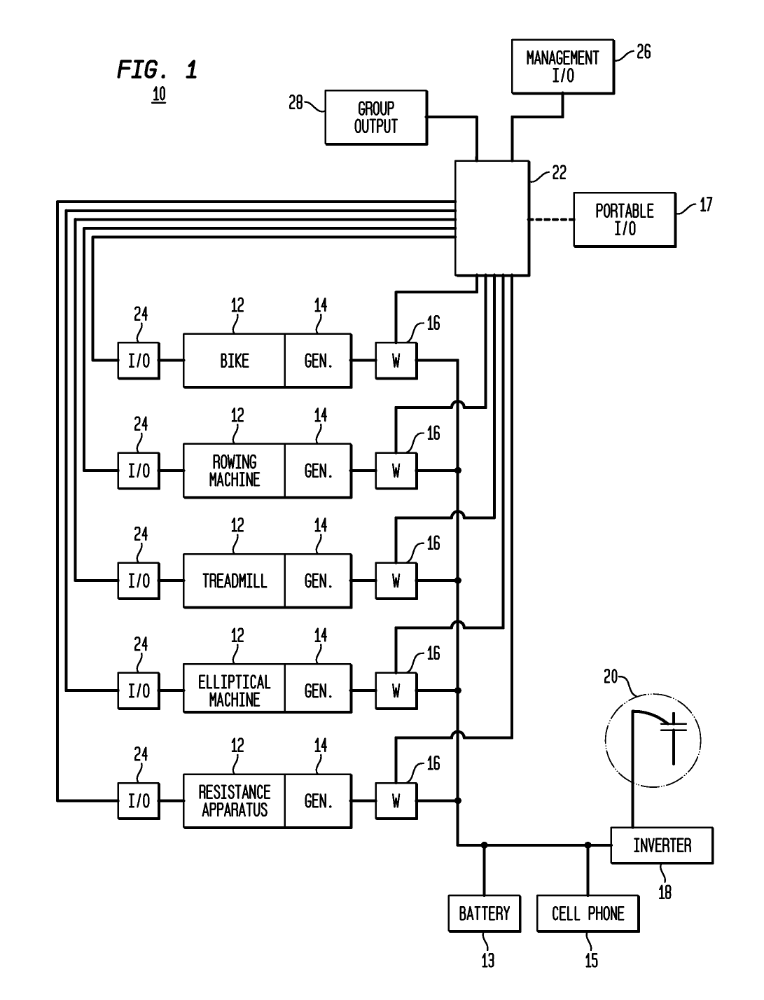

A system 10 for converting human energy to electrical energy for delivery to a desired output which motivates users through the use of environmental feedback parameters according to an illustrative embodiment of the invention is described with reference to FIG. 1. One or more fitness devices 12 are fitted with energy generators 14, for example during their manufacture or as a retrofit. Each generator 14 and/or each fitness device 12 is connected to a measuring device 16 such as wattmeter which measures the amount of energy being generated by the user. The energy generating devices 14 supply power to a power grid 20, i.e. via an inverter 18 as is commonly known in the art. In another illustrative embodiment, the energy generating devices 14 could be used to charge a battery 13 or a device such as a cell phone 15 or other battery powered device. The measuring devices 16 communicate via an electrical connection or wirelessly to a network module 22.

The network module 22 illustratively includes a processor having memory and a database for receiving measurement information from the measurement devices 16. The processor converts the measurement information associated with respective human powered devices into environmental feedback parameters and communicates the environmental feedback parameters to a respective input-output (I/O) device 24 for display or other communication to a user of the human powered device. The user I/O devices 24 may optionally receive control inputs from a user which allow the user to select between a plurality of environmental feedback parameters and/or configure a programmable workout. A user may also provide self identifying information to the network module 22. Such self identifying information may be used, illustratively, to access a user database account which stores and/or accumulates the exercise information.

An optional portable I/O device 17 may communicate with the network module 22 to allow transmission, storage, and mobility of a user's personal data to a variety of portable devices including, but not limited to, a wristwatch, personal digital assistant (PDA), cell phone. portable music player, portable memory device or laptop computer. The portable I/O device 17 would allow users to maintain a current user exercise database when away from their primary fitness facility, or when users exercise off network' (e.g. at a home gym).

An optional management input/output device 26 may communicate with the network module 22. The network module 22 can optionally communicate with the management input/output device 26 to provide management personnel with information such as total energy generated by each device or total energy returned to the power grid 20 during a specified time period or by a specified individual or group of users. The network module 22 may also communicate with one or more group output devices 28 and provide environmental feedback parameters for one or more of the human powered devices 12 during a specified period of time. In an illustrative embodiment, the information provided to the group output device 28 may optionally be controlled by management personnel via the management I/O device 26. In an another illustrative embodiment, the information provided to the group output device 28 may be communicated to members or officials of an affinity group, for example, to monitor comparative performance or manage competitions.

Human powered devices 12 may include virtually any type of fitness or recreational equipment such as treadmills, stationary bicycles, elliptical machines, rowing machines, cross training machines and even weight lifting or other resistance apparatus, as well as playground equipment such as swings, merry-go-rounds, trampolines, see-saws or rocking horses, for example, that could be adapted to power an energy generator 14. Human powered devices 12 fitted with energy generators 14 are well known in the art and various improvements can be made by persons having ordinary skill in the art to adapt efficient generators to fitness or recreational equipment and provide means for interconnecting them in a network.

The measurement devices 16 may consist of a wattmeter or other energy measuring device which may be connected to human powered device and/or the energy generator for measuring energy generated by the human powered device and/or the generator. The inverter 18 is typically a grid-connect generator which are commonly available for connecting wind turbines or solar panels to a power grid, for example.

The network module 22 may be a custom microprocessor system or virtually any type of general purpose computer adapted to receive input from a plurality of measurement devices and to provide output to one or more I/O devices 24. The I/O devices 24, management I/C devices 26 and/or group output devices 28 may be general purpose computer output monitors or may include custom displays, having buttons, audio switches, touch screens or other input/output capability.

While various human powered devices 12 may be designed and/or manufactured with integrated generators and other components for use in accordance with the various embodiments of the present invention, devices designed as conventional fitness equipment may also be retrofitted with components of the present invention such as generators, energy measuring devices, I/O devices, display devices and the like to provide human powered devices 12 according to the present invention. Additionally, human powered devices 12 may be constructed by recycling used fitness equipment thereby providing additional motivation for the environmentally conscious users of the invention.

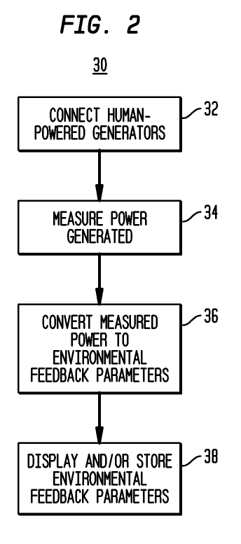

FIG. 2 is a process flow diagram illustrating a method 30 for using fitness equipment to generate power for immediate use, storage, and/or to return power to a power grid according to an illustrative embodiment of the present invention. For example, human powered generators are connected to return power to a power grid 32. Power output from the human powered generators is measured 34 individually, in groups, or collectively. The power output measurements are converted to environmental feedback parameters 36, again, individually, in groups or collectively. The environmental feedback parameters are displayed 38 or otherwise provided and utilized to motivate the person supplying energy to the human powered generators. Additionally, the feedback parameters can be collected and stored for later review and/or use.

The environmental feedback parameters provide user motivation which substantially improves the economic feasibility of installing energy generating equipment in a fitness center. Examples of environmental feedback parameters that can be provided, such as in a display or audio, as a function of generated energy include but are not limited to numerical data or graphical displays of carbon footprint size, indicators of atmospheric carbon mass reduction. trees saved, time added to the life of polar ice caps, sea-level reduction, other indicia of beneficial impact on climate change and the like. The environmental feedback parameters could be incorporated as programmable workout goals to further motivate users of the fitness equipment.

Although the present invention is described in terms of various environmental feedback parameters such as may be displayed textually or in an alpha-numeric format, it should be understood that the environmental feedback parameters may be provided via other than a display (e.g. audio, visual, virtual, sensory stimulation or the like) and may include various representations of some environmental condition. For example, rather than displaying an environmental feedback parameter comprising a number of trees saved, an alternative embodiment of the present invention may display a graphical representation of trees growing or the pleasant audio of congregating whales, or the pleasant scents of a tropical rainforest.

Although the present invention is described in terms of configuring fitness centers, it should be understood that the present invention may be used by individuals, for example in their homes, and may include any number of human powered devices used in virtually any facility, including, but not limited to, school gymnasiums, play grounds, resort spas, health clubs, home gyms, arcades, or hotel recreational facilities. It should be understood that various embodiments of the present invention may include devices that are not permanently hardwired to a power grid. For example, portable human powered devices such as bicycles or energy generating knee braces which provide environmental feedback, are envisioned using various embodiments of the present invention which may provide energy to a portable energy storage device such as a battery or capacitor. The energy storage device may later be connected to a power grid, for example, to make the generated energy widely available for use by others.

It is envisioned that use of the invention in one or more of its alternative embodiments may be encouraged by public funding. For example, embodiments of the present invention may be used in conjunction with public works projects wherein unemployed or disadvantaged individuals are encouraged to exercise in a manner that generates clean energy for their own use and/or for distribution to others. Such projects would serve the multiple purposes of helping to reduce carbon emissions, reduce national dependence on foreign energy sources while helping to reduce obesity and otherwise to improve public health. Participants in such projects and/or their sponsors may become eligible for government subsidies, health care industry subsidies and/or unemployment insurance subsidies, for example.

Although embodiments of the present invention are described in terms of providing environmental feedback parameters for a group using a network installed in a single fitness center, it should be understood that a plurality of fitness centers and/or individuals can share information over virtually any network, such as the internet, so that cumulative information for more than one facility, individual, or group may be provided to be used, for example, for comparative performance and/or competitions.

While the invention has been described with reference to an exemplary embodiment. It should be understood by those skilled in the art that various changes, omissions and/or additions may be made and equivalents presently available or as yet devised may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are merely used to distinguish one element from another.

What is claimed is

1. A method for configuring human powered machines, comprising:
providing a plurality of said human powered machines said human powered machines including means for converting mechanical energy to electrical energy;
measuring energy generated by said human powered machines to provide a measured energy amount; and
converting said measured energy amount to an environmental feedback parameter.

2. The method of claim 1 further comprising:
displaying said environmental feedback parameter.

3. The method of claim 1 wherein said human powered machines are connected to a power grid interface by a network.

4. The method of claim 1 wherein said environmental feedback parameters are indicative of a carbon footprint reduction amount.

5. The method of claim 1 wherein said measured energy amounts comprise cumulative measurements for said human powered machines.

6. The method of claim 1 wherein said environmental feedback parameters comprise measurements for a particular one of said human powered machines.

7. The method of claim 1, further comprising: storing said environmental feedback parameter.

8. A system for generating energy, comprising:
at least one human powered energy generation device; and
means for measuring energy generated by said human powered energy generation device;
means for converting an amount of energy measured by said means for measuring to a corresponding environmental feedback parameter.

9. The system of claim 8, further comprising means for displaying said environmental feedback parameter to a user.

10. The system of claim 8, further comprising means for storing said environmental feedback parameters.

11. The system of claim 8, further comprising means for storing said energy generated by said human powered energy generation device.

12. The system of claim 8 further comprising means for direct use of said energy generated by said human powered energy generation device.

13. A method of claim 8 wherein said human powered energy generation device is connected to a grid interface module for delivering energy to a power grid.

14. A system for motivating use of human power the method comprising:
at least one human powered device;
at least one energy generator configured to be powered by said human powered device(s):
at least one measuring device configured to measure energy generated by said energy generator(s):
at least one network module receiving measurements from said measuring device, said network module including a processor for converting said measurements into environmental feedback parameters; and
at least one input/output device in communication with the network module, the input/output device(s) being configured to display said environmental feedback parameters to a user of the human powered device(s).

15. The system of claim 14, further comprising: at least one grid connection module receiving energy from said energy generator(s), the grid connection module(s) being configured to convert energy for delivery to a power grid.

16. The system of claim 14 further comprising:
at least one group output device being configured to display cumulative environmental feedback parameters for users of the human powered device(s).

17. The system of claim 14 further comprising at least one energy storage device in communication with at least one of said human powered devices.

18. The system of claim 14 further comprising means for directly utilizing said energy generated by said energy generators.

19. The method of claim 1, further comprising:
directly utilizing said energy generated by said human powered machines.

20. The method of claim 1 further comprising:
converting said electrical energy to other forms of energy.

21. The system of claim 14, wherein said at least one input/output devices comprises a device selected from the group consisting of wristwatch, personal digital assistant (PDA), cell phone, portable music player, portable memory device and laptop computer.

22. The method of claim 8, further comprising:
storage means for storing energy generated by said human powered energy generation device; and
means for delivering energy from said storage means to a power grid.

23. The method of claim 22, wherein said human powered energy generation device is portable, thereby not requiring hardwiring to a power grid.
